(19) United States
(12) Patent Application Publication
(10) Pub. No.: US 2007/0035534 A1
(43) Pub. Date: Feb. 15, 2007

(54) Display driving circuit

(75) Inventor: Koji Yamazaki, Saitama (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/491,980

(22) Filed: Jul. 25, 2006

(30) Foreign Application Priority Data
Aug. 9, 2005 (JP) 2005-230270

(51) Int. Cl. G09G 5/00

(52) U.S. Cl. 345/204

(57) ABSTRACT

A display driving circuit includes a differential amplifying circuit having a first input terminal, a second input terminal, a first transistor of first conductivity type coupled between a first source potential and an output node, a second transistor of second conductivity type coupled between the output node and a second source potential and having a control electrode, and a capacitor coupled between the second input terminal of the differential amplifying circuit and the control electrode of the second transistor. The display driving circuit also includes a first switch coupled between the output terminal of the differential amplifying circuit and the control electrode of the second transistor, and a second switch coupled between the output node and the second input terminal of the differential amplifying circuit.

### BACKGROUND OF THE INVENTION

1. Field of the Invention

The present invention relates to a display driving circuit which drives a display such as an LCD (Liquid Crystal Display), and particularly to display quality maintenance at its low power consumption.

2. Description of the Related Art

FIG. 2 is a configurational diagram of a conventional LCD driving circuit.

The present LCD driving circuit drives vertically-extending display lines of an LCD, for example and has a differential amplifying circuit supplied with an analog input signal IN, an output section which outputs a signal amplified by the differential amplifying circuit at low output impedance, and a switch section for preventing an instable display at the time that the input signal IN changes.

The differential amplifying circuit comprises P channel MOS transistors (hereinafter called “PMOS”) 1P, 2P and 3P, and N channel MOS transistors (hereinafter called “NMOS”) 4N and 5N. The gate of the PMOS 1P is supplied with the input signal IN, the source thereof is connected to a source potential VDD via the PMOS 3P, and the drain thereof is connected to a ground potential GND via the NMOS 4N. The gate of the NMOS 4N is connected to the gate and drain of the NMOS 5N. The source of the NMOS 5N is connected to the ground potential GND, and the drain thereof is connected to the source of the PMOS 1P through the PMOS 2P. The gate of the PMOS 3P is supplied with a bias voltage VB for allowing a predetermined bias current to flow.

The output section has an NMOS 6N and a PMOS 7P connected in series between the ground potential GND and the source potential VDD. The gate of the NMOS 6N is connected to the drain of the PMOS 1P of the differential amplifying circuit. The gate of the PMOS 7P is supplied with the bias voltage VB. A signal S1 at a node N1 corresponding to a connecting point of the NMOS 6N and PMOS 7P is fed back to the gate of the PMOS 2P of the differential amplifying circuit. Further, a compensating capacitor 8 is connected between the node N1 and the gate of the NMOS 6N.

The switch section comprises a transfer gate (hereinafter called “TG”) 9 having an NMOS and a PMOS connected in parallel and on/off-controlled by applying complementary control signals to their gates. The switch section turns on/off between a pad 10 from which an output signal OUT is outputted, and the node N1 in accordance with a control signal EN. Incidentally, each display line for the LCD is connected to the pad 10 as a load circuit LD.

In the LCD driving circuit, the input signal applied to each vertically-extending display line changes each time, for example, horizontal scan lines for the LCD are sequentially switched. Such a control signal EN as to be brought to a level “L” only for a predetermined time interval is applied in accordance with the changing timing of the input signal IN.

When the control signal EN is brought to “L”, the TG 9 is brought to an off state, so that the node N1 and the pad 10 are disconnected from each other, thereby stopping the supply of the output signal OUT to the load circuit LD connected to the pad 10. During that time, the input signal IN is changed to a value corresponding to the following scan line, and the signal at the node N1 is also changed to a value corresponding to it.

When a predetermined time interval has elapsed, the control signal EN is returned to a level “H” and hence the TG 9 is brought to an on state. Thus, the signal at the node N1 is outputted to the pad 10 through the TG 9, so that the output signal OUT is changed to a value corresponding to a post-switching scan line.

The LCD driving circuit has the following problem.

That is, it has generally been practiced to decrease a steady-state current flowing through the differential amplifying circuit and the output section and reduce power consumption for the purpose of reducing heat generated in the LCD driving circuit. The LCD driving circuit is however accompanied by a problem that when the steady-state current is reduced, a response time at the time that the input signal IN changes becomes long, thereby degrading image quality.

### SUMMARY OF THE INVENTION

With the foregoing in view, the present invention aims to provide a display driving circuit in which degradation in image quality is less even though a steady-state current is reduced.

According to one aspect of the present invention, for attaining the above object, there is provided a display driving circuit comprising a differential amplifying circuit having a first input terminal supplied with an input signal and a second input terminal supplied with a feedback signal and outputting a signal corresponding to a difference in potential between the first and second input terminals from an output terminal thereof, a first transistor of first conductivity type connected between a first source potential and an output node and allowing a predetermined current to flow, a second transistor of second conductivity type connected between the output node and a second source potential and whose conducting state is controlled by a signal applied to a control electrode thereof, a capacitor connected between the second input terminal of the differential amplifying circuit and the control electrode of the second transistor, a first switch connected between the output terminal of the differential amplifying circuit and the control electrode of the second transistor and brought to an off state during a period in which a control signal indicative of a changing timing of the input signal is being supplied, a second switch connected between the output node and the second input terminal of the differential amplifying circuit and brought to an off state during the period in which the control signal is being supplied, a third switch connected between the control electrode of the second transistor and the second source potential and brought to an on state during the period in which the control signal is being supplied, a fourth switch connected between the second input terminal of the differential amplifying circuit and the second source potential and brought to an on state during the period in which the control signal is being supplied, and a fifth switch connected between an output pad connected with a display unit and the output node and brought to an off state during the period in which the control signal is being supplied.

The present invention is provided with the first through fifth switches for disconnecting the output node and the second transistor from the differential amplifying circuit and the output pad in accordance with the control signal supplied with the changing timing of the input signal and discharging the capacitor. Thus, at the instant when the input signal is stabilized and the control signal is released, the second transistor is connected to the output pad at an extremely low on resistance. Thus, the electric charge of a load circuit connected to the output pad is charged and discharged to make it possible to change the output signal to the voltage corresponding to the input signal rapidly. Thus, there are obtained advantageous effects in that even though a steady-state current of the differential amplifying circuit is reduced, a fast response speed is obtained and degradation in image quality is less.

As an alternative to the fourth switch connected between the second input terminal of the differential amplifying circuit and the second source potential, there is provided the fourth switch between the first and second input terminals of the differential amplifying circuit, which is brought to the on state while the control signal is being supplied.

The above and other objects and novel features of the present invention will become more completely apparent from the following description of preferred embodiments when the same is read with reference to the accompanying drawings. The drawings, however, are for the purpose of illustration only and by no means limitative of the invention.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a configurational diagram of an LCD driving circuit showing a first embodiment of the present invention;

FIG. 2 is a configurational diagram of a conventional LCD driving circuit;

FIG. 3 is a signal waveform diagram showing the operation or FIG. 1;

FIG. 4 is a configurational diagram of an LCD driving circuit illustrating a second embodiment of the present invention;

FIG. 5 is a signal waveform diagram showing the operation of FIG. 4; and

FIG. 6 is a configurational diagram of an LCD driving circuit illustrating a third embodiment of the present invention.

### DETAILED DESCRIPTION OF THE PREFERRED EMBODIMENTS

Preferred embodiments of the present invention will hereinafter be described with reference to the accompanying drawings. Incidentally, the drawings merely schematically show the shape, size and positional relationships of respective components to such a degree that the present invention can be understood. Thus, the present invention is not limited in particular.

### First Preferred Embodiment

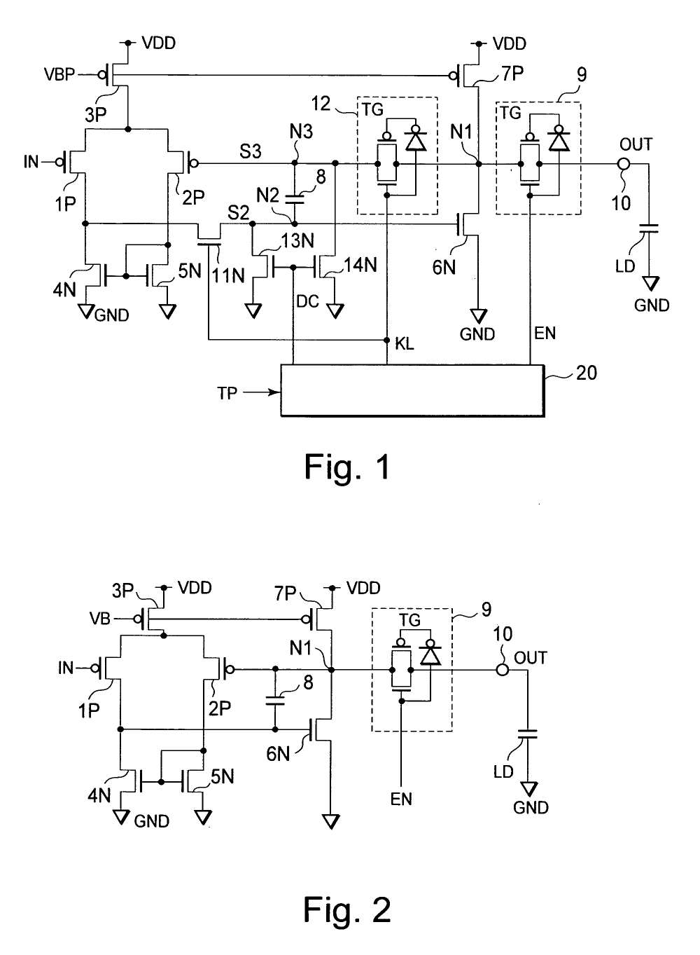

FIG. 1 is a configurational diagram of an LCD driving circuit showing a first embodiment of the present invention. Constituent elements common to those shown in FIG. 2 are given common reference numerals respectively.

The LCD driving circuit drives each vertically-extending display line of an LCD in a manner similar to FIG. 2. The LCD driving circuit has a differential amplifying circuit comprising MOS transistors of first conductivity type (e.g., PMOSs) 1P, 2P and 3P, and MOS transistors of second conductivity type (e.g., NMOSs) 4N and 5N.

An analog input signal IN is applied to the gate of the PMOS 1P, which serves as a first input terminal of the differential amplifying circuit. The source thereof is connected to a first source potential (e.g., VDD) through the PMOS 3P, and the drain thereof is connected to a second source potential (e.g., ground potential GND) through the NMOS 4N. The gate of the NMOS 4N is connected to the gate and drain of the NMOS 5N. The source of the NMOS 5N is connected to the ground potential GND, and the drain thereof is connected to the source of the PMOS 1P through the PMOS 2P. A bias voltage VBP for allowing a predetermined bias current to flow is applied to the gate of the PMOS 3P.

The drain of the PMOS 1P, which serves as an output terminal of the differential amplifying circuit, is connected to a node N2 through a switch NMOS 11N. The node N2 is connected to the gate of an NMOS 6N of an output section. The gate of the PMOS 2P, which serves as a second input terminal of the differential amplifying circuit is connected to a node N3. The node N3 is connected to a node N1 of the output section through a TG 12. And a signal at the node N1 is applied to the gate of the PMOS 2P as a feedback signal. The NMOS 11N and TG 12 are on/off-controlled by a control signal KL. When the control signal KL is “H”, the NMOS 11N and TG 12 are respectively brought to an on state, whereas when the control signal KL is “L”, they are respectively brought to an off state.

The output section comprises the NMOS 6N connected between the ground potential GND and the node N1, and a PMOS 7P connected between the node N1 and the source potential VDD and whose gate is supplied with the bias voltage VBP.

A compensating capacitor 8 is connected between the nodes N2 and N3. Switch NMOSs 13N and 14N are respectively connected between these nodes N2 and N3 and the ground potential GND. The NMOSs 13N and 14N are supplied with a control signal DC at their gates and on/off-controlled by the control signal DC.

The node N1 is connected to a pad 10 via a TG 9 on/off-controlled by a control signal EN. The TG 9 is configured in such a manner that when the control signal EN is “H”, the TG 9 is brought to an on state and outputs the signal at the node N1 to the pad 10 as an output signal OUT, and when the control signal EN is “L”, the TG 9 is brought to an off state. Incidentally, the display line of the LCD is connected to the pad 10 as a load circuit LD.

Further, the LCD driving circuit is equipped with a timing controller 20 for generating the control signals EN, KL and DC, based on a control signal TP having a predetermined pulse width supplied in sync with the changing timing of the input signal IN.

When the control signal TP rises from “L” to “H” at the start of a change in input signal IN, the timing controller 20 lowers the control signal EN from “H” to “L” approximately simultaneously with its rise. Thereafter, the timing controller 20 lowers the control signal KL and further raises the control signal DC from “L” to “H”. When a predetermined time for stabilizing the input signal IN has elapsed and the control signal TP is lowered from “H” to “L”, the timing controller 20 lowers the control signal DC at approximately the same time as its fall and thereafter raises the control signals KL and EN sequentially. Incidentally, although there are slight differences in time between the control signals TP, EN, KL and DC, they are time differences for performing reliable switch operations, and the control signals are signals approximately identical in timing to one another.

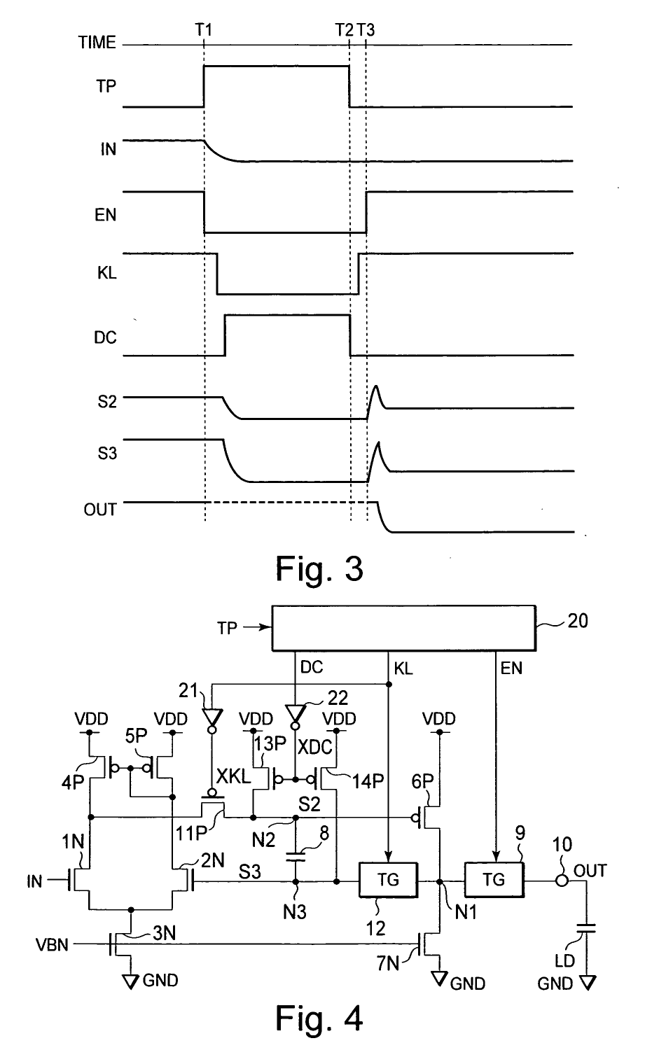

FIG. 3 is a signal waveform diagram showing the operation of FIG. 1. The operation of FIG. 1 will be explained below with reference to FIG. 3.

When a control signal TP is stable at “L”, the NMOS 11N and the TGs 9 and 12 are respectively brought to an on state and the NMOSs 13N and 14N are respectively brought to an off state. Thus, the differential amplifying circuit and the output section constitute a voltage follower circuit, and an output signal OUT identical in voltage to an input signal IN is outputted from the pad 10.

When the control signal TP supplied from outside rises together with the start of a change (e.g., from a high potential to a low potential) in the input signal IN at a time T1 of FIG. 3, a control signal EN is brought to “L” approximately simultaneously with its rise and hence the TG 9 is brought to an off state, whereby the node N1 and the pad 10 are disconnected from each other. Thus, the output signal OUT corresponding to the input signal IN immediately prior to its change is held as it is at the pad 10 and the load circuit LD connected thereto.

In succession to it, a control signal KL is brought to “L” so that the NMOS 11N and the TG 12 are turned off, thereby disconnecting the output side of the differential amplifying circuit and the node N2 from each other and also disconnecting the nodes N1 and N3 from each other. Further, a control signal DC is brought to “H” to bring each of the NMOSs 13N and 14N to an on state. Thus, a potential S2 at the node N2 and a potential S3 at the node N3 are respectively brought to a ground potential GND. Accordingly, the electric charge of the capacitor 8 is discharged.

When the input signal IN is kept stable and the control signal TP applied from outside falls at a time T2, the control signal DC is brought to “L” at approximately the same time as it to thereby bring the NMOSs 13N and 14N to an off state. Thus, the nodes N2 and N3 are disconnected from the ground potential GND.

Subsequently, the control signal KL is rendered “H” to bring the NMOSs 11N and TG 12 to an on state, so that the output side of the differential amplifying circuit and the node N2 are connected to each other and the nodes N1 and N3 are also connected to each other. Further, the control signal EN goes “H” and the TG 9 is brought to an on state, thereby connecting the node N1 and the pad 10 to each other.

Thus, the potential S3 at the node N3 steeply rises to the potential (output signal OUT corresponding to the pre-change input signal IN) of the pad 10. Since the node N2 is connected to the node N3 via the capacitor 8, the potential S2 at the node N2 rises steeply by coupling of the capacitor 8. The rise of the node N2 at this time is carried out in an extremely short period of time regardless of a stead-state current of the differential amplifying circuit.

When the potential S2 at the node N2 is raised to such a potential as to bring the NMOS 6N to a complete on state at a time T3, the electric charge held in the load circuit LD connected to the pad 10 is rapidly discharged to the ground potential GND via the NMOS 6N. Thus, the potential of the output signal OUT of the pad 10 rapidly approaches a potential corresponding to the input signal IN.

As described above, the LCD driving circuit according to the first embodiment is configured in such a manner that when the control signal TP supplied with the timing at which the input signal IN changes is brought to “H”, the differential amplifying circuit and the output section are disconnected from each other to discharge the compensating capacitor 8, and when the control signal TP is brought to “L”, the potential of the pad 10 is applied to the gate of the NMOS 6N of the output section by coupling of the capacitor 8. Thus, at the instant when the control signal TP is brought to “L” and the output of the output signal OUT is started, the NMOS 6N is capable of charging and discharging the electric charge of the load circuit LD connected to the pad 10 with an extremely low on resistance.

Thus, there are advantages in that the response time at which the input signal IN changes can be shortened even though the steady-state current of the differential amplifying circuit is reduced, and degradation in image quality is less. Further, there are advantages in that since the charging/discharging of the electric charge of the load circuit LD is performed by the NMOS 6N in a low on-resistance state, power consumed by the NMOS 6N is decreased to enable a reduction in heat generation.

### Second Preferred Embodiment

FIG. 4 is a configurational diagram of an LCD driving circuit showing a second embodiment of the present invention. Constituent elements common to those shown in FIG. 1 are given common reference numerals respectively.

The LCD driving circuit shown in FIG. 1 is called a Sink AMP which has obtained the satisfactory characteristic in the range in which the input signal IN extends from the ground potential GND to ½ of the source potential VDD. The LCD driving circuit according to the second embodiment is however called a Source AMP, whose input signal IN corresponds to a range from VDD/2 to VDD.

As shown in FIG. 4, a circuit configuration thereof is equivalent to one in which the PMOSs shown in FIG. 1 are changed to NMOSs and the NMOSs shown in FIG. 1 are changed to PMOSs, and the connections to the source potential VDD and ground potential GND are interchanged. With such implementation, suffixes (N and P) of symbols added to the respective transistors are replaced with one another. A control signal XKL obtained by inverting a control signal KL by an inverter 21 is applied to the gate of a PMOS 11P. A control signal XDC obtained by inverting a control signal DC by an inverter 22 is applied to the gates of PMOSs 13P and 14P.

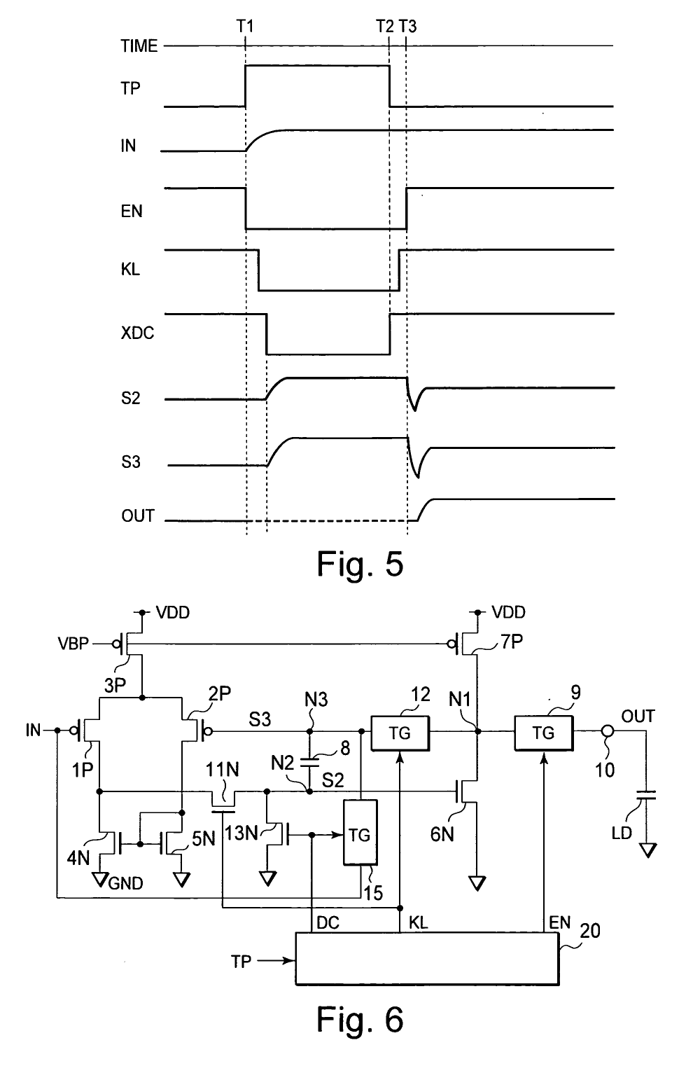

FIG. 5 is a signal waveform diagram showing the operation of FIG. 4. The operation of FIG. 4 will be explained with reference to FIG. 5. Incidentally, the following operation is basically identical to that of the LCD driving circuit of FIG. 1.

When a control signal TP supplied from outside rises together with the start of a change (e.g., from a low potential to a high potential) in the input signal IN at a time T1 of FIG. 5, a control signal EN is brought to “L” approximately simultaneously with its rise and hence a TG 9 is brought to an off state, whereby a node N1 and a pad 10 are disconnected from each other. Thus, an output signal OUT corresponding to the input signal IN immediately prior to its change is held as it is at the pad 10 and a load circuit LD connected thereto.

In succession to the above, the control signal KL is brought to “L” so that the PMOS 11P and a TG 12 are turned off, thereby disconnecting the output side of a differential amplifying circuit and a node N2 from each other and also disconnecting the node N1 and a node N3 from each other. Further, the control signal DC is rendered “H” to bring each of the PMOSs 13P and 14P to an on state. Thus, a potential S2 at the node N2 and a potential S3 at the node N3 are respectively brought to the source potential VDD. Accordingly, an electric charge is charged into a capacitor 8.

When the input signal IN is kept stable and the control signal TP supplied from outside falls at a time T2, the control signal DC is brought to “L” at approximately the same time as its operation to thereby bring the PMOSs 13P and 14P to an off state. Thus, the nodes N2 and N3 are disconnected from the source potential VDD.

Subsequently, the control signal KL is rendered “H” to bring the PMOSs 11P and TG 12 to an on state, so that the output side of the differential amplifying circuit, and the node N2 are connected to each other and the nodes N1 and N3 are also connected to each other. Further, a control signal EN goes “H” and hence the TG 9 is brought to an on state, thereby connecting the node N1 and the pad 10 to each other.

Thus, the potential S3 at the node N3 is steeply lowered to the potential (output signal OUT corresponding to the pre-change input signal IN) of the pad 10. Since the node N2 is connected to the node N3 via the capacitor 8, the potential S2 at the node N2 drops steeply by coupling of the capacitor 8. The fall of the potential at the node N2 at this time is carried out in an extremely short period of time regardless of a stead-state current of the differential amplifying circuit.

When the potential S2 at the node N2 is lowered to such a potential as to bring a PMOS 6P to a complete on state at a time T3, a current flows through a load circuit LD connected to the pad 10 via the PMOS 6P from the source potential VDD. Thus, the potential of the output signal OUT of the pad 10 rapidly approaches a potential corresponding to the input signal IN.

As described above, the LCD driving circuit according to the second embodiment is configured in such a manner that when the control signal TP supplied with the timing at which the input signal IN changes is brought to “H”, the differential amplifying circuit and the output section are disconnected from each other to charge the compensating capacitor 8, and when the control signal TP is brought to “L”, the potential of the pad 10 is applied to the gate of the PMOS 6P of the output section by coupling of the capacitor 8. Thus, at the instant when the control signal TP is brought to “L” and the output of the output signal OUT is started, the PMOS 6P is capable of charging and discharging the electric charge of the load circuit LD connected to the pad 10 with an extremely low on resistance. Accordingly, the present LCD driving circuit brings about advantages similar to the first embodiment.

### Third Preferred Embodiment

FIG. 6 is a configurational diagram of an LCD driving circuit illustrating a third embodiment of the present invention. Constituent elements common to those shown in FIG. 1 are given common reference numerals respectively.

The present LCD driving circuit is configured in such a manner that the NMOS 14N shown in FIG. 1 is omitted, and a TG 15 is provided between an input terminal (the gate of a PMOS 1P supplied with an input signal IN) and a node N3 and on/off-controlled by a control signal DC. The present embodiment is similar in other configuration to FIG. 1.

In the LCD driving circuit, when the control signal DC is brought to “H” during a period in which the input signal IN changes, the TG 15 is brought to an on state and a potential S3 at the node N3 becomes the same potential as the input signal IN. Thus, when the input signal IN is stabilized, the potential S3 at the node N3 becomes a potential corresponding to the post-change input signal IN, and a capacitor 8 is charged to the same voltage as the post-change input signal IN. When the control signal DC is brought to “L” and control signals KL and EN are respectively brought to “H”, the output signal OUT (i.e., the voltage corresponding to the pre-change input signal IN) retained at a pad 10 up to now is applied to a node N2 via the capacitor 8. Therefore, a potential S2 at the node N2 reaches a potential corresponding to the amount of change in the input signal IN. Thus, the conducting state of an NMOS 6N is controlled according to the amount of change in the input signal IN, so that the output signal OUT of the pad 10 rapidly approaches a potential corresponding to the input signal IN.

As described above, the LCD driving circuit according to the third embodiment is configured in such a manner that when a control signal TP supplied with the timing at which the input signal IN changes is brought to “H”, a differential amplifying circuit and an output section are disconnected from each other to charge the compensating capacitor 8 to the same voltage as the input signal IN, and when the control signal TP is brought to “L”, the potential of the pad 10 is applied to the NMOS 6N of the output section by coupling of the capacitor 8. Thus, when the control signal TP is brought to “L” and the output of the output signal OUT is started, the NMOS 6N is controlled to the conducting state corresponding to the amount of change in the input signal IN. That is, when the amount of change in the input signal IN is large, the electric charge of a load circuit LD connected to the pad 10 can be charged and discharged with an extremely low on resistance in a manner similar to the first embodiment. While a relatively large on resistance is taken when the amount of change in the input signal IN is small, needless charge/discharge can be suppressed by the excessiveness to the load circuit LD by overdrive.

Incidentally, while the third embodiment is configured as one corresponding to the Sink AMP of the first embodiment, it can be applied even to the Source AMP of the second embodiment in like manner. That is, the present embodiment may be configured in such a manner that in FIG. 4, the PMOS 14P is omitted and the TG 15 is provided between the input terminal and the node N3, and the TG 15 is on/off-controlled by the control signal DC. Thus, an advantage similar to the third embodiment is obtained even with respect to the Source AMP.

While the present invention has been described with reference to the illustrative embodiments, this description is not intended to be construed in a limiting sense. Various modifications of the illustrative embodiments, as well as other embodiments of the invention, will be apparent to those skilled in the art on reference to this description. It is therefore contemplated that the appended claims will cover any such modifications or embodiments as fall within the true scope of the invention.

What is claimed is:

1. A display driving circuit comprising:
a differential amplifying circuit having a first input terminal, a second input terminal, and an output terminal outputting a signal corresponding to a difference in potential between the first and second input terminals;
a first transistor of first conductivity type coupled between a first source potential and an output node and flowing a predetermined current;
a second transistor of second conductivity type coupled between the output node and a second source potential and having a control electrode, a conducting state being controlled by a signal applied to the control electrode;
a capacitor coupled between the second input terminal of the differential amplifying circuit and the control electrode of the second transistor;
a first switch coupled between the output terminal of the differential amplifying circuit and the control electrode of the second transistor and brought to an off state in response to a control signal having a first logic level;
a second switch coupled between the output node and the second input terminal of the differential amplifying circuit and brought to an off state in response to the control signal having the first logic level;
a third switch coupled between the control electrode of the second transistor and the second source potential and brought to an on state in response to the control signal having a second logic level;
a fourth switch coupled between the second input terminal of the differential amplifying circuit and the second source potential and brought to an on state in response to the control signal having the second logic level; and
a fifth switch coupled between an output pad coupled with a display unit and the output node and brought to an off state in response to the control signal having the second logic level.

2. The display driving circuit according to claim 1, wherein each of the first, third and fourth switches comprises a second conductivity type transistor, and each of the second and fifth switches comprises a transfer gate.

3. A display driving circuit comprising:
a differential amplifying circuit having a first input terminal, a second input terminal, and output terminal outputting a signal corresponding to a difference in potential between the first and second input terminals;
a first transistor of first conductivity type coupled between a first source potential and an output node and flowing a predetermined current;
a second transistor of second conductivity type coupled between the output node and a second source potential and having a control electrode, a conducting state being controlled by a signal applied to the control electrode;
a capacitor coupled between the second input terminal of the differential amplifying circuit and the control electrode of the second transistor;
a first switch coupled between the output terminal of the differential amplifying circuit and the control electrode of the second transistor and brought to an off state in response to a control signal having a first logic level;
a second switch coupled between the output node and the second input terminal of the differential amplifying circuit and brought to an off state in response to the control signal having the first logic level;
a third switch coupled between the control electrode of the second transistor and the second source potential and brought to an on state in response to the control signal having a second logic level;
a fourth switch coupled between the first and second input terminals of the differential amplifying circuit and brought to an on state in response to the control signal having the second logic level; and
a fifth switch coupled between an output pad coupled with a display unit and the output node and brought to an off state in response to the control signal having the first logic level.

4. The display driving circuit according to claim 3, wherein each of the first and third switches comprises a second conductivity type transistor, and each of the second, fourth and fifth switches comprises a transfer gate.

5. A display driving circuit comprising:
a differential amplifying circuit having a first input terminal, a second input terminal, and an output terminal outputting a signal corresponding to a difference in potential between the first and second input terminals;
a first transistor of first conductivity type coupled between a first source potential and an output node and flowing a predetermined current;
a second transistor of second conductivity type coupled between the output node and a second source potential and having a control electrode, a conducting state being controlled by a signal applied to the control electrode;
a capacitor coupled between the second input terminal of the differential amplifying circuit and the control electrode of the second transistor;
a first switch coupled between the output terminal of the differential amplifying circuit and the control electrode of the second transistor, the first switch being selectively connecting the output terminal and the control electrode of the second transistor; and
a second switch coupled between the output node and the second input terminal of the differential amplifying circuit, the second switch being selectively connecting the output node and the second input terminal.

6. The display driving circuit according to claim 5, further comprising:
a third switch coupled among one electrode of the capacitor, another electrode of the capacitor and the second source potential, the third switch being selectively connecting one and another electrodes of the capacitor to the second source potential.

7. The display driving circuit according to claim 6, wherein the third switch comprises a fourth switch coupled between the one electrode of the capacitor and the second source potential and a fifth switch coupled between another electrode of the capacitor and the second source potential.
